(19) United States
(12) Patent Application Publication
(10) Pub. No.: US 2021/0104787 A1
(43) Pub. Date: Apr. 8, 2021

(54) BATTERY FOR USE IN THE STRATOSPHERE

(71) Applicant: Loon LLC, Mountain View, CA (US)

(72) Inventor: Kevin Anderson, Sunnyvale, CA (US)

(21) Appl. No.: 16/594,373

(22) Filed: Oct. 7, 2019

(51) Int. Cl. H01M 10/615; H01M 10/625; H01M 10/6551; H01M 10/658; B64B 1/40; B60L 8/00; B60L 58/12; B60L 58/27; B64D 27/24; B60L 50/64; H02J 7/35

(52) U.S. Cl. CPC H01M 10/615; H01M 10/625; H01M 10/6551; H01M 10/658; B64B 1/40; B60L 8/003; B60L 2200/10; B60L 58/27; B64D 27/24; B60L 50/64; H02J 7/35; H01M 2220/20; B60L 58/12

(57) ABSTRACT

Aspects of the disclosure relate to batteries for use in the stratosphere, such as those employed on aerial vehicles. The battery may include an outer case structure, a thermal insulator such as foam arranged within the outer case structure, a battery management unit and a plurality of battery cells both arranged within the thermal insulator, and a heater arranged within the thermal insulator and around the battery cells. In some instances, the battery may also include a thermal reflector arranged between the heater and the thermal insulator, wherein a surface of the thermal reflector is arranged to reflect heat back towards ones of the plurality of battery cells. In some instances, the thermal insulator may include overlapping baffles to reduce an amount of air passing from the outer case and through the thermal insulator. In some instances, the outer case may include a plastic layer with a low emissivity coating.

### BACKGROUND

Computing devices such as personal computers, laptop computers, tablet computers, cellular phones, and countless types of Internet-capable devices are increasingly prevalent in numerous aspects of modem life. As such, the demand for data connectivity via the Internet, cellular data networks, and other such networks, is growing. However, there are many areas of the world where data connectivity is still unavailable, or if available, is unreliable and/or costly. Accordingly, additional network infrastructure is desirable.

Some systems may provide such additional network access via high-altitude platforms such as balloons and other aerial vehicles operating in the stratosphere. These platforms may therefore be operating in extreme cold environments, such as −100 C/173K or colder. However, such environments can be taxing on the hardware used to power these platforms. For example, while lithium-ion batteries represent a useful balance of power density, energy density, rapid charge and discharge capability, and other performance characteristics which make them prime choices for many terrestrial applications, these batteries function optimally in a fairly narrow window of thermal conditions. Outside of this window, these batteries may become unsafe (at higher temperatures) and ineffective as an energy storage device (at extremely cold temperatures).

In addition, since most terrestrial and aerospace applications involve heavy duty cycles for batteries that causes them to self-heat and increase in temperature, current art has focused on effective means of cooling batteries such as with forced air convection or liquid conduction. For instance, in terrestrial applications such as electric vehicles, battery operations for backup systems for houses, drones or planes, these devices are pulling a large amount of power relative to the size of the batteries used. This results in the batteries generating quite a bit of internal heat on the battery cells which corresponds to a relatively large flow of energy through a small space. In addition, the batteries' wires as well as the bus bars of the vehicle also get hot, which can result in additional heat to the battery cells, so thermal regulation of batteries for terrestrial applications has typically focused on how to cool batteries or thermally insulate the batteries from higher temperatures outside of batteries, rather than to keep batteries warm.

### BRIEF SUMMARY

One aspect of the disclosure provides a battery for use in the stratosphere. The battery includes an outer case structure, a thermal insulator arranged within the outer case structure, a battery management unit and a plurality of battery cells both arranged within the thermal insulator, and a heater arranged within the thermal insulator and around the plurality of battery cells.

In one example, the battery also includes a thermal reflector arranged between the heater and the thermal insulator. A surface of the thermal reflector is arranged to reflect heat back towards ones of the plurality of battery cells. In this example, the thermal reflector includes a substrate and a low emissivity coating. In another example, the cells are lithium-ion cells. In another example, the thermal insulator includes foam. In this example, the foam includes an aluminum outer layer. In addition or alternatively, the foam is electrically non-conductive. In another example, the thermal insulator includes overlapping baffles to reduce an amount of air passing from the outer case and through the thermal insulator. In another example, the thermal insulator includes a phase change material. In another example, the outer case includes a plastic layer with a low emissivity coating. In another example, the heater includes a microwire wound heater. In another example, the heater includes etched foil resistors. In another example, the heater includes a polyimide film casing. In another example, the heater includes a silicone casing. In another example, the heater includes a power density which differs according to expected differences in heat transfer rates of different ones of the plurality of battery cells. In another example, the battery also includes a second heater, wherein the heater and the second heater are configured to heat different ones of the plurality of battery cells differently.

Another aspect of the disclosure provides a system comprising an aerial vehicle including a battery. The battery includes an outer case structure, a thermal insulator arranged within the outer case structure, a battery management unit and a plurality of battery cells both arranged within the thermal insulator, and a heater arranged within the thermal insulator and around the plurality of battery cells.

In one example, the aerial vehicle is a balloon. In another example, the aerial vehicle further includes one or more solar panels, and wherein the battery is configured to store power generated by the solar panels. In another example, the battery further includes a thermal reflector arranged between the heater and the thermal insulator, wherein a surface of the thermal reflector is arranged to reflect heat back towards ones of the plurality of battery cells.

### BRIEF DESCRIPTION OF THE DRAWINGS

FIG. 1 is an example system including a network of aerial vehicles in accordance with aspects of the disclosure.

FIG. 2 is an example of an aerial vehicle in accordance with aspects of the present disclosure.

FIG. 3 is an example of an aerial vehicle in flight in accordance with aspects of the disclosure.

FIG. 4 is a perspective view of an example battery in accordance with aspects of the disclosure.

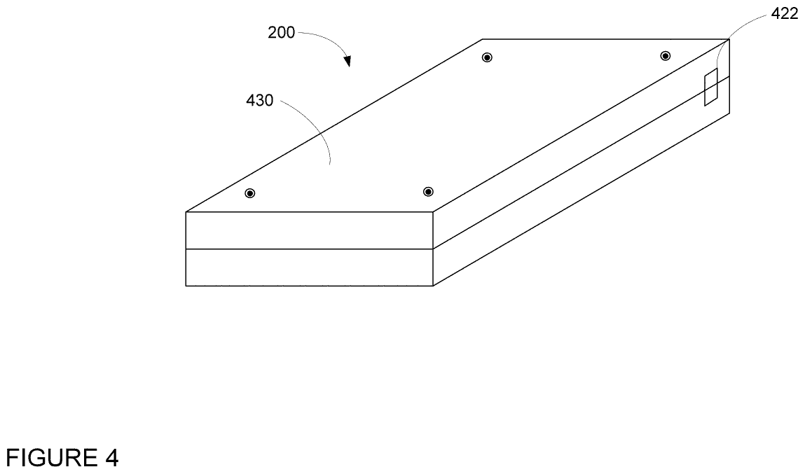

FIG. 5 is a cross sectional view of the example battery of FIG. 4 in accordance with aspects of the disclosure.

FIG. 6 is an example cross sectional view of an example battery in accordance with aspects of the disclosure

FIG. 7 is a perspective view of an example battery in accordance with aspects of the disclosure.

FIG. 8 is a cross sectional view of the example battery of FIG. 7 in accordance with aspects of the disclosure.

FIG. 9 is a block diagram of a payload in accordance with aspects of the disclosure.

### DETAILED DESCRIPTION

### Overview

The present disclosure generally relates to batteries for use in extreme environments, such as the extreme cold of the stratosphere which can be as cold as −100 C/173K or colder. For example, while lithium-ion batteries represent a useful balance of power density, energy density, rapid charge and discharge capability, and other performance characteristics which make them prime choices for many terrestrial applications, these batteries function optimally in a fairly narrow window of thermal conditions. Outside of this window, these batteries may become unsafe (at higher temperatures) and ineffective as an energy storage device (at extremely cold temperatures).

In addition, since most terrestrial and aerospace applications involve heavy duty cycles for batteries, current art has focused on effective means of cooling batteries such as with forced air convection or liquid conduction. For instance, in terrestrial applications such as electric vehicles, battery operations for backup systems for houses, drones or planes, these devices are pulling a large amount of power relative to the size of the batteries used. This results in the batteries generating quite a bit of internal heat on the battery cells which corresponds to a relatively large flow of energy through a small space. In addition, the batteries' wires as well as the bus bars of the vehicle also get hot, which can result in additional heat to the battery cells, so thermal regulation of batteries for terrestrial applications has typically focused on how to cool batteries or thermally insulate the batteries from higher temperatures outside of batteries, rather than to keep batteries warm.

The same approaches used to cool a battery that is hot do not translate to warming a battery that is cold, even though the same thermodynamic principles are at work. Moreover, typical solutions for thermal regulation of batteries in cold environments involves thermal wraps or blankets to keep batteries warm. Such approaches while often effective for terrestrial applications may be ineffective or simply too heavy for aerospace applications. For instance, for aerial vehicles which are lighter than air, such as balloons, and which do not include propellers or other sophisticated propulsion systems have very low power draws on the batteries. For example, computers and communication systems may not draw enough power to allow the batteries to keep themselves warm from self-heating and energy flow.

To address these issues, a self-contained, thermally robust battery may be provided. For instance, the battery may be able to alter its immediate (i.e. within the container of the battery itself) environment including manipulating the thermal environment.

The self-contained battery may include an outer case structure with a very lowemissivity coating. This coating may act as a “first line of defense” for the battery in extremely cold environments, diminishing the effects of radiative heat transfer allowing the battery to regulate its immediate surrounding with less influence from the broader environment beyond. Inside of the outer case structure may include a thermal insulator. The thermal insulator may include two pieces of foam which overlap one another with baffles to prevent or reduce an amount of cold air from bleeding into the battery and through the foam. The thermal insulator may enable the battery to better retain heat generated by the battery, for instance, by diminishing the effects of convective and conductive modes of heat transfer.

The battery may also include a heater. The heater may be wrapped around the battery cells and/or portions of a clamshell structure that holds the battery cells. The heater itself may be electrically connected to the battery management unit. The battery management unit may include a thermal control system that measures the temperature of the cells or other elements within the battery. This heater may establish thermal boundary conditions and cause the cells to only “see” a desired regulated temperature in the radiated heat (Infrared) spectrum in addition to directly conducting heat into the cells the heater is touching.

In addition or as an alternative to the thermal insulator and/or the heater, an internal radiative heat transfer shield or a “thermal reflector” may be used. The thermal reflector may be a low emissivity material coating on a substrate, which reflects photons and heat. If a thermal insulator is used, the thermal reflector may be arranged on an interior surface of the thermal insulator which is oriented towards the battery cells. If a heater is used, the thermal reflector may be arranged such that the heater is arranged between the battery cells and the thermal reflector.

The features described herein may provide a self-contained, thermally robust battery which in order to enable more stable performance in a cold environment as compared to typical batteries. As such, the features described herein can be utilized in extreme conditions such as those of the Stratosphere. At the same time, the materials and configurations used may be especially useful for lighter than air vehicles as they may add very little additional weight as compared to typical batteries, increasing the effective energy density of the battery, and may even reduce the need for other devices which would have been used external to the battery to regulate the temperature of the battery.

### Example System

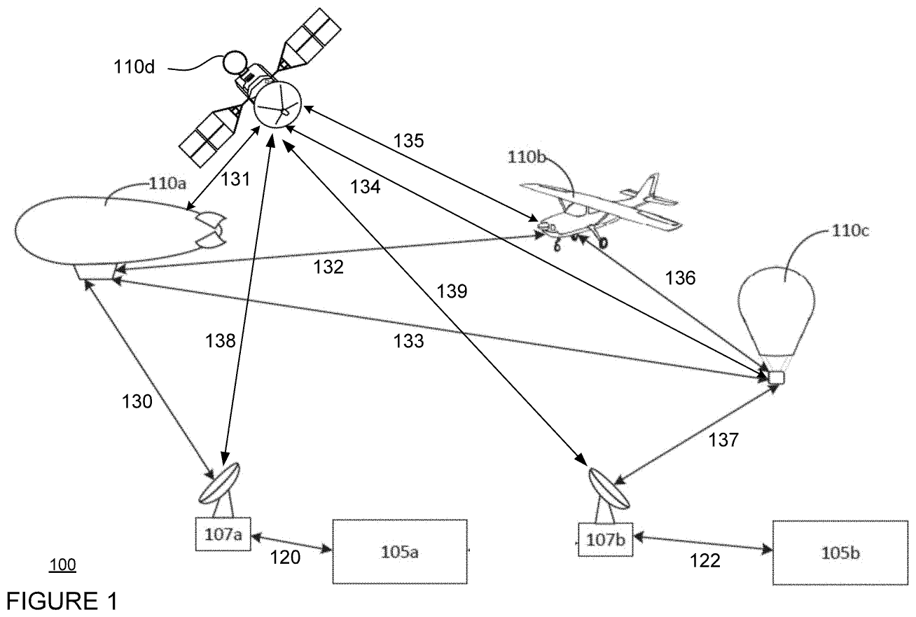

FIG. 1 is a block diagram of an example directional point-to-point network 100. The network 100 is a directional point-to-point computer network consisting of nodes mounted on various land- and air-based devices, some of which may change position with respect to other nodes in the network 100 over time. For example, the network 100 includes nodes associated with each of two land-based datacenters 105a and 105b (generally referred to as datacenters 105), nodes associated with each of two ground stations 107a and 107b (generally referred to as ground stations 107), and nodes associated with each of four airborne high altitude platforms (HAPs) 110a-110d (generally referred to as HAPs 110). As shown, HAP 110a is an aerial vehicle (here depicted as a blimp), HAP 110b is an airplane, HAP 110c is an aerial vehicle (here depicted as a balloon), and HAP 110d is a satellite. In some embodiments, nodes in network 100 may be equipped to perform FSOC, making network 100 an FSOC network. Additionally or alternatively, nodes in network 100 may be equipped to communicate via radio-frequency signals or other communication signal capable of travelling through free space. Arrows shown between a pair of nodes represent possible communication links 120, 122, 130-137 between the nodes. The network 100 as shown in FIG. 1 is illustrative only, and in some implementations the network 100 may include additional or different nodes. For example, in some implementations, the network 100 may include additional HAPs, which may be balloons, blimps, airplanes, unmanned aerial vehicles (UAVs), satellites, or any other form of high-altitude platform.

In some implementations, the network 100 may serve as an access network for client devices such as cellular phones, laptop computers, desktop computers, wearable devices, or tablet computers. The network 100 also may be connected to a larger network, such as the Internet, and may be configured to provide a client device with access to resources stored on or provided through the larger computer network. In some implementations, HAPs 110 can include wireless transceivers associated with a cellular or other mobile network, such as eNodeB base stations or other wireless access points, such as WiMAX or UMTS access points. Together, HAPs 110 may form all or part of a wireless access network. HAPs 110 may connect to the datacenters 105, for example, via backbone network links or transit networks operated by third parties. The datacenters 105 may include servers hosting applications that are accessed by remote users as well as systems that monitor or control the components of the network 100. HAPs 110 may provide wireless access for the users, and may route user requests to the datacenters 105 and return responses to the users via the backbone network links.

### Example Aerial Vehicle

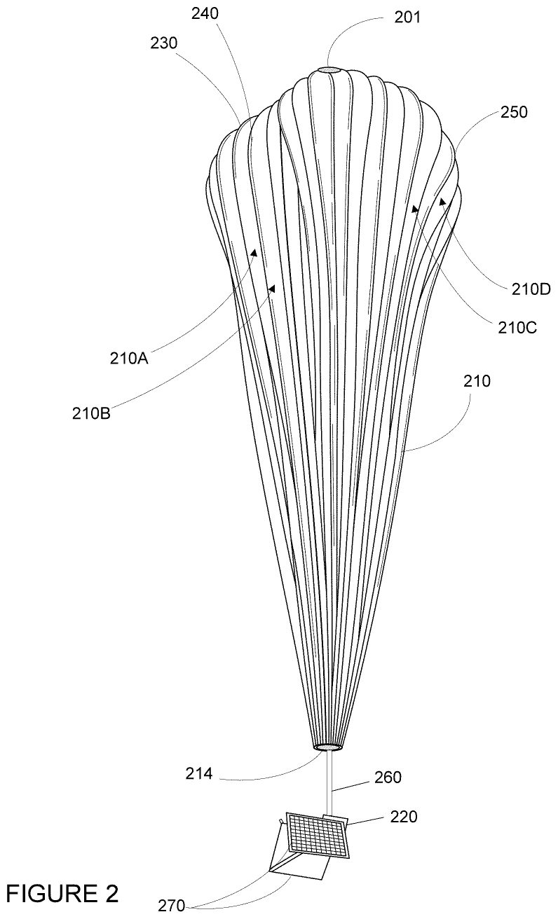

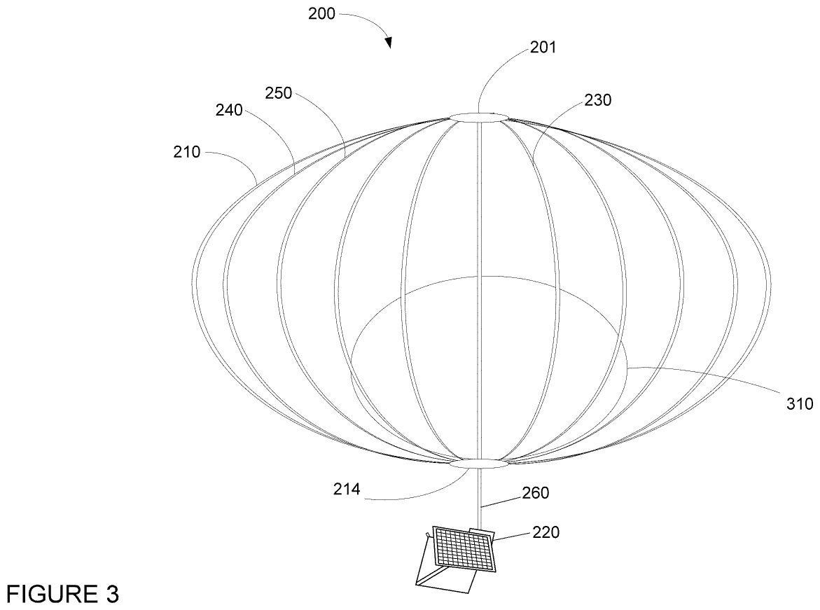

FIGS. 2 and 3 are examples of an aerial vehicle 200 which may correspond to HAP 110c, again, depicted here as a balloon. For ease of understanding, the relative sizes of and distances between aspects of the aerial vehicle 200 and ground surface, etc. are not to scale. As shown, the aerial vehicle 200 includes an envelope 210, a payload 220 and a plurality of tendons 230, 240 and 250 attached to the envelope 210. The envelope 210 may take various forms. In one instance, the envelope 210 may be constructed from materials (i.e. envelope material) such as polyethylene that do not hold much load while the aerial vehicle 200 is floating in the air during flight. Additionally, or alternatively, some or all of envelope 210 may be constructed from a highly flexible latex material or rubber material such as chloroprene. Other materials or combinations thereof may also be employed. Further, the shape and size of the envelope 210 may vary depending upon the particular implementation. Additionally, the envelope 210 may be filled with various gases or mixtures thereof, such as helium, or any other lighter-than-air gas. The envelope 210 is thus arranged to have an associated upward buoyancy force during deployment of the payload 220.

The payload 220 of aerial vehicle 200 may be affixed to the envelope by a connection 260 such as a cable or other rigid structure. The payload 220 may include a computer system (not shown), having one or more processors and on-board data storage. The payload 220 may also include various other types of equipment and systems (not shown) to provide a number of different functions. For example, the payload 220 may include various communication systems such as optical and/or RF, a navigation software module, a positioning system, a lighting system, an altitude control system (configured to change an altitude of the aerial vehicle in order to follow navigation instructions), a plurality of solar panels 270 for generating power, and a power supply 280 (such as one or more of the batteries discussed further below) to store power generated by the solar panels. The power supply may also supply power to various components of aerial vehicle 200.

In view of the goal of making the envelope 210 as lightweight as possible, it may be comprised of a plurality of envelope lobes or gores that have a thin film, such as polyethylene or polyethylene terephthalate, which is lightweight, yet has suitable strength properties for use as an envelope. In this example, envelope 210 is comprised of envelope gores 210A-210D.

Pressurized lift gas within the envelope 210 may cause a force or load to be applied to the aerial vehicle 200. In that regard, the tendons 230, 240, 250 provide strength to the aerial vehicle 200 to carry the load created by the pressurized gas within the envelope 210. In some examples, a cage of tendons (not shown) may be created using multiple tendons that are attached vertically and horizontally. Each tendon may be formed as a fiber load tape that is adhered to a respective envelope gore. Alternately, a tubular sleeve may be adhered to the respective envelopes with the tendon positioned within the tubular sleeve.

Top ends of the tendons 230, 240 and 250 may be coupled together using an apparatus, such as top plate 201 positioned at the apex of envelope 210. A corresponding apparatus, e.g., base plate or bottom plate 214, may be disposed at a base or bottom of the envelope 210. The top plate 201 at the apex may be the same size and shape as and bottom plate 214 at the bottom. Both caps include corresponding components for attaching the tendons 230, 240 and 250 to the envelope 210.

FIG. 3 is an example of the aerial vehicle 200 in flight when the lift gas within the envelope 210 is pressurized. In this example, the shapes and sizes of the envelope 210, connection 260, envelope 310, and payload 220 are exaggerated for clarity and ease of understanding. During flight, these balloons may use changes in altitude to achieve navigational direction changes. In this regard, the envelope 310 may be a ballonet that holds ballast gas (e.g., air) therein, and the envelope 210 may hold lift gas around the ballonet. For example, the altitude control system of the payload 220 may cause air to be pumped into a ballast within the envelope 210 which increases the mass of the aerial vehicle and causes the aerial vehicle to descend. Similarly, the altitude control system may cause air to be released from the ballast (and expelled from the aerial vehicle) in order to reduce the mass of the aerial vehicle and cause the aerial vehicle to ascend. Alternatively, in a reverse ballonet configuration, the envelope 310 may hold lift gas therein and the envelope 210 may hold ballast gas (e.g., air) around the envelope 310, and the envelope 310 may hold the lift gas therein. In either case, the envelope 310 may be attached to one or both of the top plate 201 or the bottom plate 214 (attachment to the bottom plate being depicted in FIG. 3).

### Example Battery

The present disclosure generally relates to batteries for use in extreme environments, such as the extreme cold of the stratosphere which can be as cold as −100 C/173K or colder. For example, while lithium-ion batteries represent a very nice balance of power density, energy density, rapid charge and discharge capability, and other performance characteristics which make them prime choices for many terrestrial applications, these batteries function optimally in a fairly narrow window of thermal conditions. Outside of this window, these batteries may become unsafe (at higher temperatures) and worthless as an energy storage device (at extremely cold temperatures).

The same methods used to cool a battery that is hot do not translate to warming a battery that is cold even though the same thermodynamic principles are at work. Moreover, typical solutions for thermal regulation of batteries in cold environments involves thermal wraps or blankets to keep batteries warm. Such approaches while often effective for terrestrial applications may be ineffective or simply too heavy for aerospace applications. For instance, for aerial vehicles which are lighter than air and which do not include propellers or other sophisticated propulsion systems have very low power draws on the batteries. For example, computers and communication systems may not draw enough power to allow the batteries to keep themselves warm from self-heating and energy flow.

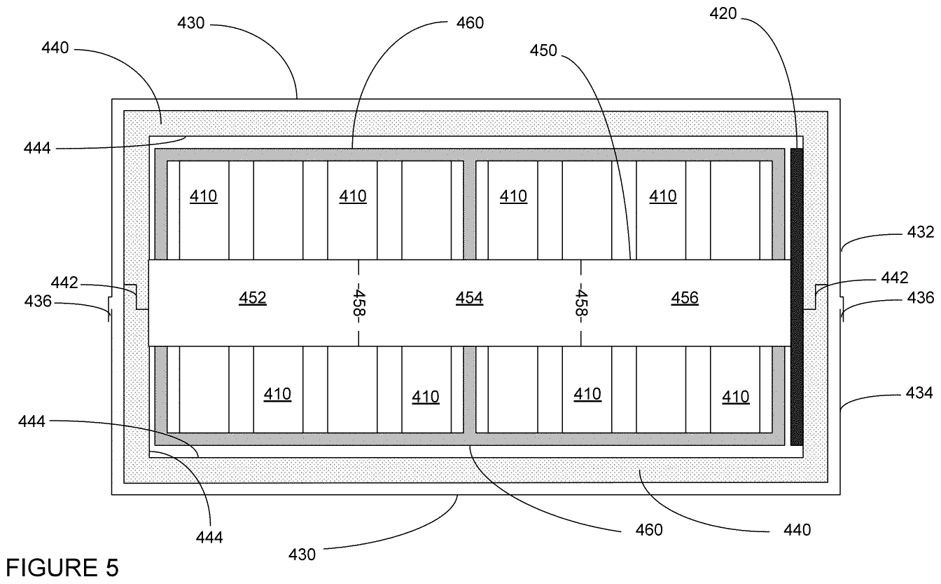

To address these issues, a self-contained, thermally robust battery may be provided. For instance, the battery may be able to alter its immediate (within its' own container) environment including manipulating the thermal environment. For instance, turning to FIGURE depicts a perspective view of an example battery 400. FIG. 5, is a cross-sectional view of the battery 400. As shown, the battery may include a plurality of battery cells 410 which are connected to a battery management unit (BMU) 420. In one example, the cells may be lithium-ion battery cells. Alternatively, the cells may be low-temperature tolerant battery cells. However, use of such cells typically comes at other technical compromises, such as reduced energy density.

The BMU 420 may be connected to the cells 410 as well as an electrical interface 422 or a connector configured to enable the flow of current into and out of the battery 400. For instance, the interface 422 may be connected to a power bus, cable or other conduits for providing power to various systems of the payload and/or the aerial vehicle 200. Although not shown, the interface 422 may be arranged to extend through respective openings in both a thermal insulator 440 and an outer case structure 430 of the battery.

This outer case structure 430 may be made of plastic which is approximately 2 mm thick or more or less. The outer case structure may also include a low emissivity coating on the order of an average of 0.1 or within a range of 0.1-0.15 or lower (e.g. less than 0.15 or lower than 0.1) on an emissivity scale of 0 to 1 (where “0” corresponds to a shiny mirror to “1.0” which corresponds to blackbody). For instance, the coating may include the outer case structure being metalized with a very thin layer (on the order of several angstroms thick) of aluminum, copper, silver, or any other material with low infrared emissivity. In addition, the outer case structure 430 may include two pieces of plastic 432, 434 which overlap one another at a baffle 436 (exaggerated for ease of understanding) which extends around a perimeter of the battery 400 in order to prevent or reduce an amount of cold air from an external environment of the battery from bleeding into the internal environment of the battery. This coating may act as a “first line of defense” for the battery 400 in extremely cold environments such as the stratosphere, diminishing the effects of radiative heat transfer allowing the battery to regulate its immediate surrounding with less influence from the broader environment beyond.

The thermal insulator 440 may be arranged within the outer case structure 430. In some instances, the thermal insulator may be any type of foam, including, for instance, molded EPP foam, foam with an aluminum outer layer, electrically non-conductive foam so that the thermal insulator cannot cause a short within the battery, etc. The thermal insulator may include two pieces of foam which overlap one another at a baffle 442 which extends around a perimeter of the thermal insulator in order to prevent or reduce an amount of cold air from an external environment of the batter from bleeding into the internal environment of the battery and through the thermal insulator 440. While the thermal insulator may include a phase change material, this may result in the battery being too heavy for use in lighter than air vehicles such as balloons. In any event, the thermal insulator 440 may enable the battery to better retain heat generated by the battery, for instance, by diminishing the effects of convective and conductive modes of heat transfer.

The battery may also include a heater 450. The heater which may be of several different types, including a wire-wound heater or etched foil resistors encased in polyimide (such as Kapton) or silicone. The silicone may be preferred as it may disperse heat better and reduce micro-hotspots, whereas the Kapton may result in hot spots and cold spots at different points along the heater depending on how well thermally coupled it is to substrates such as the battery cells. The heater may be wrapped around the battery cells and/or portions of a clamshell structure 460 that holds the battery cells. As an example, the clamshell structure may be a pair of molded plastic (or another material) parts which constrain the battery cells in place to allow them to be electrically interconnected to one another and the BMU, which protect the cells from mechanical shock, movement, and other detrimental physical effects. The heater itself may be electrically connected to the BMU 420.

The BMU 420 may include a circuit board that controls the functioning of the battery 400. The BMU may monitor various aspects of the battery 400 such as voltages of the cells 410 and/or total voltage, state of charge and discharge, electrical current into and out of the battery, etc. and a such, may function as a typical battery management system. In addition, the BMU 420 may also include a thermal control system that measures the temperature of the cells or other elements within the battery using one or more sensors such as a thermistor, thermocouple, or RTD, and then uses this thermal measurement to control/regulate power to the heater 450. The BMU may control the heater 450 in order to establish thermal boundary conditions and cause the cells 410 to only “see” a desired regulated temperature in the radiated heat (Infrared) spectrum in addition to directly conducting heat into the cells the heater is touching.

When in use, for instance in the aerial vehicle 200 in the stratosphere, the battery 400 may be subject to large thermal disparities due to the increased role that radiative heat transfer plays in non-terrestrial applications. For example, a relatively small battery may “see” deep space at 4K in one direction and only a foot away also “see” albedo bouncing off the earth's surface at 288K. This can cause very large thermal gradients within a battery, which in turn, can have an adverse effect on the battery's capacity due to uneven balancing between the battery cells. In other words, battery cells have different storage capacities at different temperatures, and when a battery is charging, the battery's energy storage capacity is limited by the capacity of the coldest battery cells.

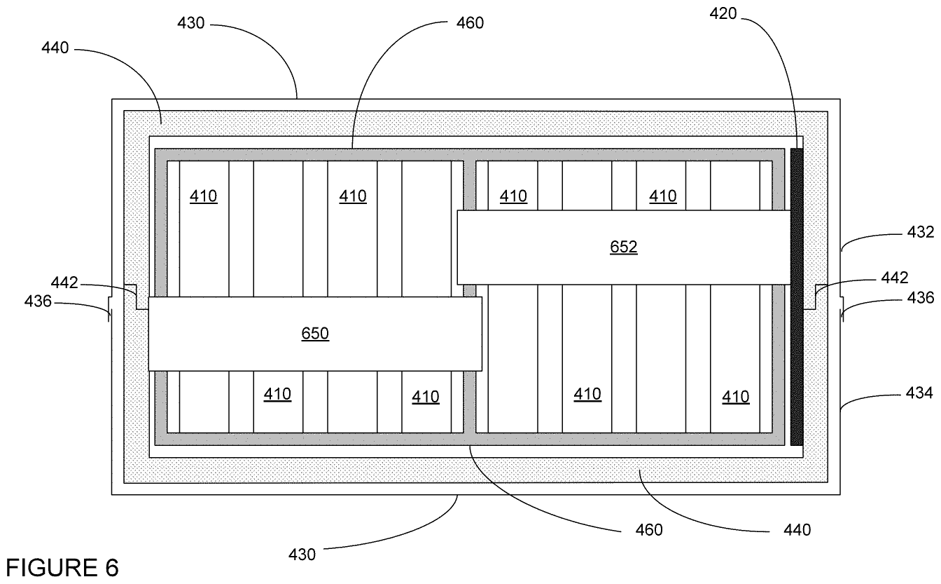

To mitigate this thermal gradient and allow the battery to store the maximum amount of energy, the heater 450 may have a varied power density. That way the cells which consistently face the greatest (or highest) heat transfer may receive more heat than cells which are not transferring as much heat or rather, have lower heat transfer rates. For instance, the battery 400 may be constructed to have a power density which differs according to expected differences in heat transfer rates of different ones of the plurality of battery cells. This may allow the battery, or rather the BMU 420, to selectively heat lower-temperature areas of the battery more in order to maintain a more even or uniform temperature throughout. To enable this, one may increase the resistance of the heater at different locations or increase the density of the wires or foil thereby changing the power density of the heater 450. The battery 400 may alternately employ multiple heaters 650, 652 as depicted in FIG. 6, with a control algorithm controlling the heaters all to a consistent temperature, but this is a more complex solution.

In any configuration, the heater may be controlled by the BMU 420 which uses the temperature data from sensors as described above in order to control power to the heater. Such a configuration may allow the BMU to accurately regulate the temperature of the battery to the desired set point/operational temperature, turning the heaters on and off and regulating their output using the information from the sensors. As an example, a battery may be constructed such that the power generated by the heater is 2 watts per inch square in a middle section 454, 5 watts per square in in one end section 452, 10 watts per square in another end section 456. For ease of understanding, these sections are delineated by dashed-lines 458. Of course, the exact configuration of the heater may be dependent on the size, configuration, and temperatures experienced (or expected to be experienced) by different battery cells in the battery. The latter may be determined empirically by launching a lighter than air vehicle and monitoring battery temperature of differently sized and configured batteries or mathematically by running simulations to estimate battery temperatures of differently sized and configured batteries.

In addition or as an alternative to the thermal insulator and/or the heater, an internal radiative heat transfer shield or “thermal reflector” may be used. The thermal reflector may be constructed of a simple substrate such as a plastic or polymer molded into the desired geometry to fit within the battery, then coated with a very thin (several Angstroms thick) very lowemissivity coating such as aluminum, silver, or another lowemissivity material. The thermal reflector may minimize the amount of power that a battery must spend to keep itself warm because the thermal reflector would reflect heat radiated from the battery cells and/or the externally-facing side of the heater back towards the interior of the battery pack. This in turn would make the battery more efficient at its own thermal regulation, allowing the battery to provide more power to the outside system without increasing in size, mass, etc. due to internal consumption of energy for heating which as noted above is a critical consideration in lighter than air vehicles.

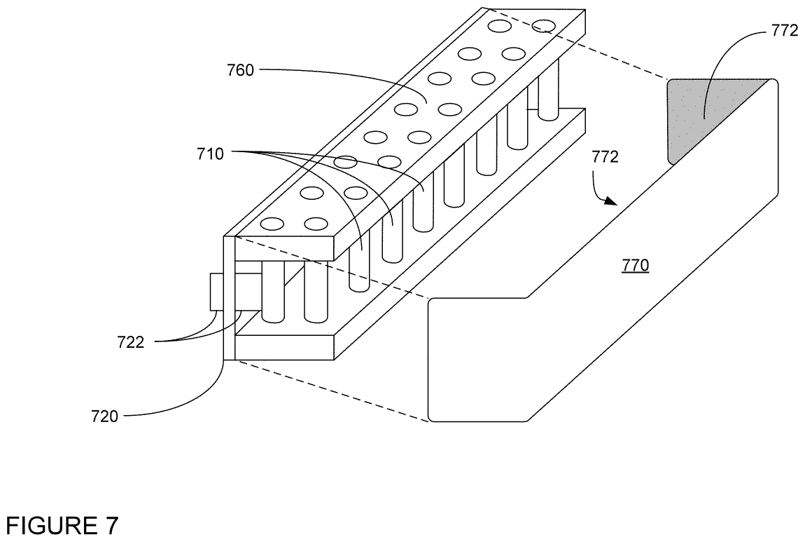

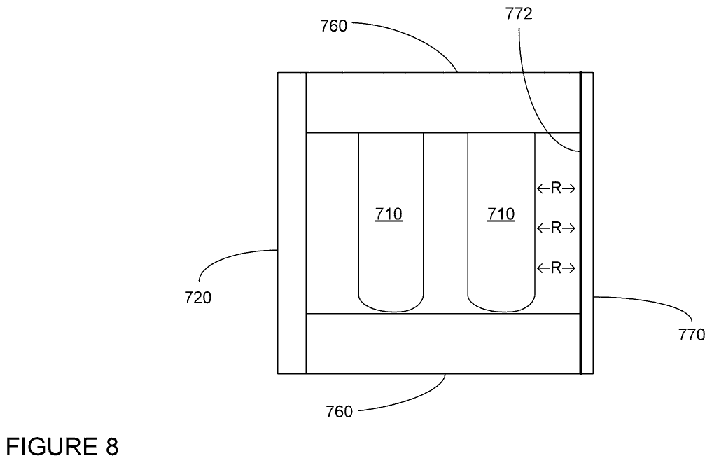

For instance, FIG. 7 depicts an example thermal reflector 770 shown as broken-away from cells 710 of a battery 700 which may be configured the same or similarly to battery 400. FIG. 8 is a cross-sectional view of the battery 700 with the reflector 770 shown as adjacent to the cells 710 and clamshell structure 760. In these examples, the battery 700 includes a plurality of cells 710, a BMU 720, an electrical interface 722, and a clamshell structure 760 corresponding to cell 410, BMU 420, and clamshell structure 460. While battery 700 may also include an outer case structure 430, thermal insulator 440, and heater, these are not depicted for ease of understanding.

The thermal reflector 770 may include a low-emissivity material coating which reflects photons and heat arranged on a substrate (e.g. a very thin layer of polished aluminum on a plastic substrate). For instance, this coating may be arranged on a surface, such as surface 772, that is oriented towards the cells of the battery. For instance, Arrows “R” of FIG. 8 represented heat from the cells 710 being reflected off of the surface 772 and back towards the cells 710. The thermal reflector may be arranged around the clamshell structure 460 or 760 and/or the cells 410 or 710 and not the BMU 420 or 720 in order to avoid overheating the BMU. For instance, if a thermal insulator, such as thermal insulator 440, is used, the thermal reflector 770 may be arranged on one or more interior surfaces of the thermal insulator which is oriented towards the cells (such as interior surfaces 444 in FIG. 5) such that the coating is oriented towards the cells. In addition, if a heater, such as heater 450, is used, the thermal reflector 770 may be arranged such that the heater is arranged between the cells and the thermal insulator and such that the coating is oriented towards the cells and heater.

### Example Control System

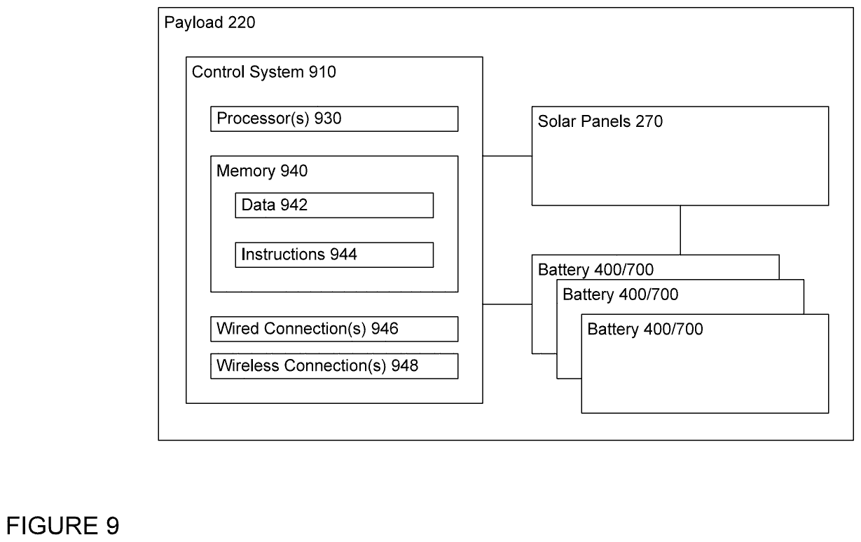

Operation of the battery 400 or 700 may be controllable by a control system of the aerial vehicle. For instance, a control system of the aerial vehicle may communicate with the BMU 420, 720 via the interface 422, 722. FIG. 9 is an example block diagram of the payload 220 including a control system 910, solar panels 270, and one or more batteries, here corresponding to battery 400 and/or 700. Of course, the control system 910 could be located elsewhere on the aerial vehicle and may not actually be a part of the payload. The control system 910 may control the function of the solar panels 270 which generate power which can be stored in the one or more batteries. In some instances, the control system 910 may also assist the battery or multiple batteries in monitoring internal temperatures using a series of sensors such as thermistors or thermocouples, and controlling/regulating a battery's thermal environment by powering and depowering any heaters contained within the batteries.

The memory 940 stores information accessible by the one or more processors 930, including instructions 944 and data 942 that may be executed or otherwise used by the processors 930. The memory 940 may be of any type capable of storing information accessible by the one or more processors, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 944 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 942 may be retrieved, stored or modified by the one or more processors 930 in accordance with the instructions 944. For instance, although the claimed subject matter is not limited by any particular data structure, the data may be stored in computing device registers, in a relational database as a table having a plurality of different fields and records, XML documents or flat files. The data may also be formatted in any computing device-readable format. For instance, data may store information about the expected location of the sun relative to the earth at any given point in time as well as information about the location of network targets.

The one or more processors 930 may be any conventional processors, such as commercially available CPUs or GPUs. Alternatively, the one or more processors may be a dedicated device such as an ASIC or other hardware-based processor. Although FIG. 9 functionally illustrates the processor 930, memory 940, and other elements of the control system 910 as being within the same block, it will be understood that the processors or memory may actually include multiple processors or memories that may or may not be stored within the same physical housing. For example, memory may be a hard drive or other storage media located in a housing different from that of the control system 910.

The control system 910 may also include one or more wired connections 946 and wireless connections 948 (such as transmitters/receivers) to facilitate communication with other devices, such as devices arranged at different locations on the aerial vehicles as well as other devices of network 100.

The features described herein may provide a self-contained, thermally robust battery which in order to enable more stable performance in a cold environment as compared to typical batteries. As such, the features described herein can be utilized in extreme conditions such as those of the Stratosphere. At the same time, the materials and configurations used may be especially useful for lighter than air vehicles as they may add very little additional weight as compared to typical thermal solutions for batteries, increasing the effective energy density of the battery, and may even reduce the need for other devices which would have been used external to the battery to regulate the temperature of the battery.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A battery for use in the stratosphere, the battery comprising:
an outer case structure;
a thermal insulator arranged within the outer case structure;
a battery management unit and a plurality of battery cells both arranged within the thermal insulator; and
a heater arranged within the thermal insulator and around the plurality of battery cells.

2. The battery of claim 1, further comprising a thermal reflector arranged between the heater and the thermal insulator, wherein a surface of the thermal reflector is arranged to reflect heat back towards ones of the plurality of battery cells.

3. The battery of claim 2, wherein the thermal reflector includes a substrate and a low emissivity coating.

4. The battery of claim 1, wherein the cells are lithium-ion cells.

5. The battery of claim 1, wherein the thermal insulator includes foam.

6. The battery of claim 5, wherein the foam includes an aluminum outer layer.

7. The battery of claim 5, wherein the foam is electrically non-conductive.

8. The battery of claim 1, wherein the thermal insulator includes overlapping baffles to reduce an amount of air passing from the outer case and through the thermal insulator.

9. The battery of claim 1, wherein the thermal insulator includes a phase change material.

10. The battery of claim 1, wherein the outer case includes a plastic layer with a low emissivity coating.

11. The battery of claim 1, wherein the heater includes a microwire wound heater.

12. The battery of claim 1, wherein the heater includes etched foil resistors.

13. The battery of claim 1, wherein the heater includes a polyimide film casing.

14. The battery of claim 1, wherein the heater includes a silicone casing.

15. The battery of claim 1, wherein the heater includes a power density which differs according to expected differences in heat transfer rates of different ones of the plurality of battery cells.

16. The battery of claim 1, further comprising a second heater, wherein the heater and the second heater are configured to heat different ones of the plurality of battery cells differently.

17. A system comprising an aerial vehicle including a battery, the battery comprising:
an outer case structure;
a thermal insulator arranged within the outer case structure;
a battery management unit and a plurality of battery cells both arranged within the thermal insulator; and
a heater arranged within the thermal insulator and around the plurality of battery cells.

18. The system of claim 17, wherein the aerial vehicle is a balloon.

19. The system of claim 17, wherein the aerial vehicle further includes one or more solar panels, and wherein the battery is configured to store power generated by the solar panels.

20. The system of claim 17, wherein the battery further includes a thermal reflector arranged between the heater and the thermal insulator, wherein a surface of the thermal reflector is arranged to reflect heat back towards ones of the plurality of battery cells.
